(19) United States
(12) Patent Application Publication
(10) Pub. No.: US 2009/0230923 A1
(43) Pub. Date: Sep. 17, 2009

(54) Battery management circuit

(75) Inventors: Peter F. Hoffman, Avon, OH (US); Michael J. Brandon, II, North Ridgeville, OH (US); David A. Kaplin, Mayfield Heights, OH (US)

Correspondence Address: MICHAEL C. POPHAL;EVEREADY BATTERY COMPANY INC, 25225 DETROIT ROAD, P O BOX 450777, WESTLAKE, OH, 44145, US

(73) Assignee: Eveready Battery Company, Inc.

(21) Appl. No.: 12/075,900

(22) Filed: Mar. 14, 2008

(51) Int. Cl. H02H 7/18; H02J 7/00

(52) U.S. Cl. 320/136

(57) ABSTRACT

A non-rechargeable battery includes a housing with an opening and a cover that closes the opening in the housing. The housing and the cover define a volumetric region within the battery. The battery also includes at least one electrochemical cell and a management component, both located in the volumetric region. The management component includes programmable electrical circuitry that selectively interrupts electrical current output from the cell out of the battery based on an actively monitored state of the battery. The chemistry of the battery is Li—FeS₂ or other non-rechargeable chemistry.

### TECHNICAL FIELD

The following generally relates to a battery management circuit located in/within the housing of a battery, and finds particular application to a non-rechargeable (primary) Lithium-Iron Disulfide (Li—FeS₂) battery.

### BACKGROUND

The term battery has referred to a device with one or more electrochemical cells that supply electric current for a load. Generally, batteries come in two types: primary; and secondary. Primary batteries supply energy through an irreversible reaction and cannot/should not be recharged. Secondary batteries, on the other hand, supply energy through a reversible reaction and can be recharged, for example, by supplying a charging current to the battery, in the opposite direction of the discharge current. Both primary and secondary batteries are manufactured in various sizes, chemistries, voltages, and form factors, and are employed to power various battery-powered devices.

It has been desirable to automatically, selectively inhibit the current supplied by a primary battery to a battery-powered device. For example, with a flashlight or other electrical device it may be desirable to inhibit current flow from a primary battery to the device when a temperature of the battery and/or the device exceeds a preset temperature threshold. Such a temperature may be indicative of an electrical short within the battery and/or device, excessive current draw by a load, ambient temperature conditions, and/or another temperature based fault condition. To facilitate this, a positive temperature coefficient (PTC) device has been included in a battery in the path of the electrical current. Generally, the resistance of the PTC device is a function of its temperature and abruptly rises when its temperature exceeds a trip threshold, which reduces current flow therethrough.

More particularly, the PTC device includes a polymer/graphite matrix sandwiched between metal foil. When the temperature of the PTC device exceeds a trip temperature of about 85 degrees Celsius (° C.), the polymer/graphite expands, thereby increasing its resistance and reducing current. In one instance, the PTC device has a resistance of about 35 milliohms (mΩ) at 20° C. and increases about 0.4 mΩ/° C. up to the trip temperature threshold, at which the resistance increases rapidly up to about 100Ω. When the PTC device cools down below the trip temperature, its resistance tends to resets back towards to a pre-trip resistance state.

Unfortunately, the PTC device has several shortcomings. For example, the PTC device trips based solely on its temperature, and there may be other characteristics which would desirably trigger inhibiting current flow. Furthermore, the PTC device, when tripped, merely limits or reduces current (via the 100Ω resistance), but does not stop current flow through the PTC. As such, even during a temperature based fault condition, current continues to be supplied by the battery and the current continues to heat the PTC device. In addition, the PTC device is subject to a trip/reset delay after a fault condition due to the time it takes to heat up/cool down relative to the trip threshold. Further, the PTC device is a passive device and may end up oscillating between low and high resistance states if the temperature of the PTC device oscillates about the threshold temperature. And after a reset, if a reset is even possible, the resistance of the PTC device typically is higher (e.g., about double) than its initial pre-trip resistance, which decreases high rate performance. Moreover, the PTC device is sensitive to compression forces, which may delay or prevent PTC activation. This sensitivity to pressure may also limit the cell design choices, particularly with respect to closures and sealing methods used in high volume production settings.

### SUMMARY

Aspects of the application address the above matters, and others.

In one aspect, a non-rechargeable battery includes a housing with an opening and a cover that closes the opening in the housing. The housing and the cover define a volumetric region within the battery. The battery also includes at least one electrochemical cell and a management component, both located in the volumetric region. The management component includes programmable electrical circuitry that selectively interrupts electrical current output from the cell out of the battery based on an actively monitored state of the battery. The chemistry of the battery is Li—FeS₂ or other non-rechargeable chemistry.

In another aspect, a method of controlling an electrical current output of a primary battery includes determining an electrical operating characteristic of the primary battery, and executing an executable instruction that causes interruption of the electrical current output of the primary battery based on the electrical operating characteristic.

In another aspect, a primary battery includes a cell that stores energy, an output terminal, a switch located between the cell and the output terminal and within the primary battery, wherein the switch includes an active electrical component that is powered by the cell, and a microprocessor that controls the switch so as to prevent electrical current flow from the cell through the switch and to the output terminal under a preset condition, wherein the microprocessor is located within the primary battery.

In another aspect, the primary battery further includes an electrical current level sensor that determines a level of the electrical current flow from the cell, and the microprocessor controls the switch so as to prevent electrical current flow through the switch when the level exceeds a preset programmable current level threshold.

In another aspect, the primary battery further includes an electrical current direction sensor that determines a direction of the electrical current flow of the cell, and the microprocessor controls the switch so as to prevent electrical current flow through the switch when the direction does not satisfy a preset programmable electrical current direction.

In another aspect, the primary battery further includes a temperature sensor that determines a temperature of the battery, and the microprocessor controls the switch so as to prevent electrical current flow through the switch when the temperature exceeds a preset programmable temperature threshold.

In another aspect, the primary battery further includes a state of charge determiner that determines a state of charge of the battery, wherein the microprocessor outputs the state of charge through the terminal.

In another aspect, the primary battery further includes a power source that powers at least active components of the switch and the microprocessor, wherein the power source uses power from the cell to power the at least active components of the switch and the microprocessor.

Those skilled in the art will recognize still other aspects of the present application upon reading and understanding the attached description.

### BRIEF DESCRIPTION OF THE DRAWINGS

The application is illustrated by way of example and not limitation in the figures of the accompanying drawings, in which like references indicate similar elements and in which:

FIG. 1 illustrates an example battery;

FIG. 2 illustrates the example battery in connection with a battery-powered device;

FIG. 3 illustrates an example battery management circuit;

FIG. 4 illustrates a first example switch of the battery management circuit;

FIG. 5 illustrates a second example switch of the battery management circuit;

FIG. 6 illustrates a third example switch of the battery management circuit;

FIG. 7 illustrates a flow diagram.

### DETAILED DESCRIPTION

The following relates to a primary battery battery-management circuit that manages the power output by the primary battery. The battery management circuit is described herein in connection with a Lithium-Iron Disulfide (Li—FeS₂) disposable battery. However, the battery operation management circuit may be utilized with a different non-rechargeable battery chemistry. A primary battery including the battery management circuit may be used in connection with various battery-powered appliances such as, but not limited to, lighting appliances (e.g., flashlights, table lamps, etc.) and non-lighting electrical appliances (e.g., games, cellular phones, battery life extenders which use primary batteries to recharge one or more secondary batteries on a separate device, digital cameras, computers, etc.).

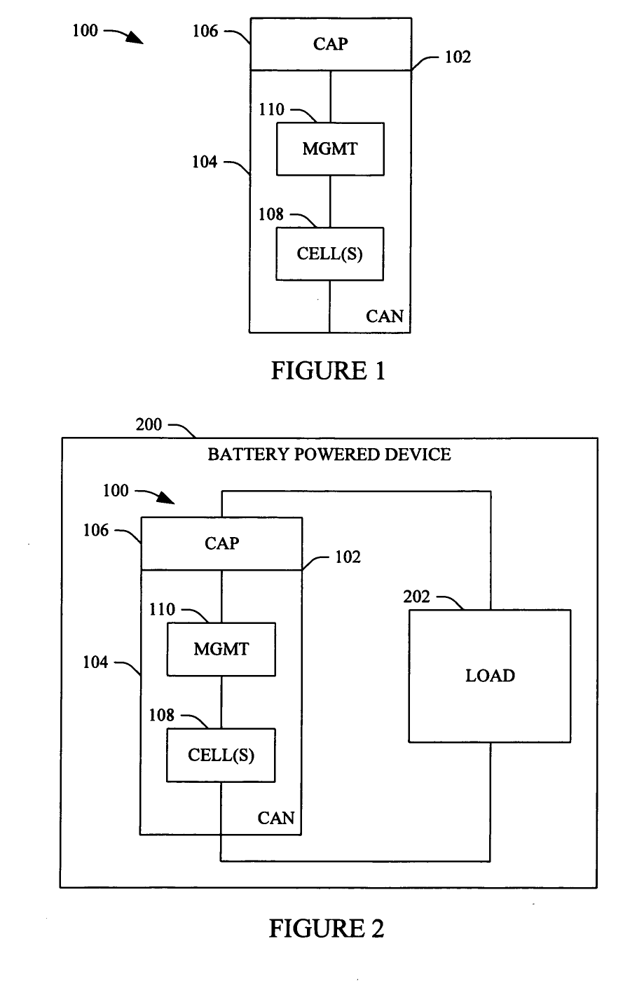

Initially referring to FIG. 1, an example battery 100 is illustrated. As noted above, in this example the battery 100 is a Li—FeS₂ primary battery. As shown, the battery 100 includes a housing 102, including a first portion or can 104 and a second portion or cap 106, at least one cell 108 and a battery management circuit (mgmt) 110. The battery 100 may be, for example, an FR6 type cylindrical battery in which the can 104 includes a closed bottom, a closed cylindrical side wall, and an open top that is closed by the cap 106. Other form factors may also be possible. As defined herein, the battery 100 includes and is enclosed by the can 104 and cap 106.

Given the propensity for organic electrolytes required by Li—FeS₂ cells to dissolve or degrade many materials (and especially plastics), the battery management circuit 110 must be located outside of the chemical region of the cell 108 (i.e., the electrochemically active portions of the cell—anode, cathode and electrolyte), either within the can 104 or as an integrated part of the closure cap 106. In the illustrated example, the battery management circuit 110 resides in the can 104 between the cell 108 and the cap 106. In another instance, the battery management circuit 110 may be located at least partially within or outside of the can 104. In yet another instance, the battery management circuit 110 may be located in the cap 106. Moreover, in another instance the battery management circuit 110 or an additional battery management circuit 110 may reside between the cell 108 and the can 104. However, to the extent that many consumer batteries have standardized sizes, it is important that the battery management circuit still occupy as little volume as possible regardless of whether it is carried within the container or attached thereto.

It is to be appreciated that the battery management circuit 110 may include one or more active and/or passive components. In addition, the circuit 110 may be implemented in an integrated chip (IC), an application specific integrated chip (ASIC), or otherwise. In each instance, the circuit 110 does not require a passive activation method (i.e., experiencing a set temperature) and instead it actively monitors a condition and then implements a pre-programmed response thereto. In doing so, the circuit will not experience any chemical phase change (as in PTCs), nor does it require any moving parts (as in some memory metal springs).

The battery management circuit 110 may be included in addition to or in alternative to one or more other devices of the battery 100 such as a positive temperature coefficient (PTC) device. In one instance, the foot print of the battery management circuit 110 is about the same as or is smaller than the foot print of a PTC device for a battery. In this instance, the battery management circuit 110 may reside in the region allocated for the PTC device or in another region. In another instance, a size of the can 104 and/or the cell 108 is configured so that the cell 108 and the battery management circuit 110 both fit in the can 104.

In the illustrated example, an anode of the cell 108 is in electrical communication with the can 104, and a cathode of the cell 108 is in electrical communication with the cap 106 through the battery management circuit 110. In another embodiment, the terminals may be switched so that the anode of the cell 108 is in electrical communication with the cap 106 through the battery operation management circuit 110, and the cathode of the cell 108 is in electrical communication with the can 104. Although the terminals of the battery 100 are shown as being located on different sides of the battery 100, it is to be appreciated that in another embodiment the terminals may be located on a same side of the battery 100.

The battery 100 may also include a pressure relief vent (not shown), including an aperture (not shown) that is selectively sealed by a vent ball (not shown) or the like. When the internal pressure of the cell 108 exceeds a predetermined level, the vent ball is forced out of the aperture to release pressurized fluids from the cell 108. Other venting devices are possible, including without limitation foil vents or other similar rupturable members. In each case, the battery management circuit 110 must be configured to accommodate the venting device, in terms of having sufficient clearance to allow the outflow of gases and/or the displacement of the ball/laminate member.

As noted above, the battery management circuit 110 may also be employed with a battery other than a Li—FeS₂ battery. Non-limiting examples of suitable primary batteries include alkaline (e.g., Zn/MnO₂) or carbon zinc (CZn) etc. Battery packs are also contemplated. Significantly, all of these primary systems are designed to be low cost and disposable, such that the use of expensive or complex current interruption devices was not previously seen as feasible or desirable in such primary systems.

Turning to FIG. 2, the primary battery 100 is shown in connection with a battery-powered device 200. Such a device 200 may include a battery receiving region configured to receive one or more of the batteries 100. In this example, the battery 100 supplies power for a load 202.

The battery management circuit 110 may include a microprocessor or the like that executes programmable executable instructions and/or provides various battery management functions. For instance, the battery management circuit 110 selectively interrupts current output by the battery. As used herein, interrupt refers to completely or substantially stopping current flow, as compared to currently available PTC devices and/or memory metal springs which physically deform at predetermined temperature. Nevertheless, there still may be a slight leakage of current through a transistor or the like.

The battery management circuit 110 selectively interrupts current output by the battery based on various information and/or states of the battery 100. For example, the battery management circuit 110 may interrupt current flow based on the magnitude of the current and/or the direction of the current. In another example, the battery management circuit 110 additionally or alternatively interrupts current flow based on the temperature of the battery 100. In another instance, the battery management circuit 110 provides various information. Such information includes, but is not limited to, the state of charge of the battery 100. Other management functions are also contemplated.

Such management allows the battery 100 to be inherently safe under fault and/or abusive conditions such as, but not limited to, forced discharge, forced charge, etc. In addition, the battery management circuit 110 allows for the following: low resistance during normal operation, high resistance so as to interrupt current flow during an undesirable state, reverse current (charge) prevention, current sensing, fuel gauging, and/or other capabilities.

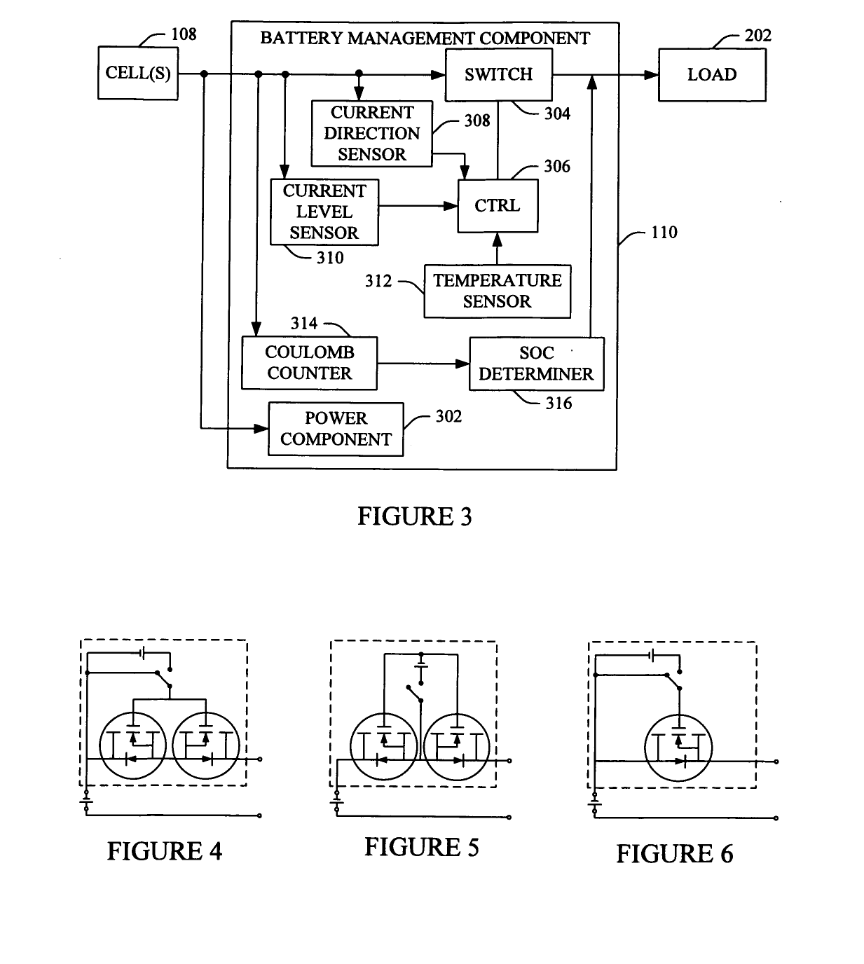

FIG. 3 illustrates an example battery management circuit 110 in connection with the cell 108 and the load 202. Electrical current from the cell 108 is supplied to the load 202 via a switch 304. A control component (CTRL) 306 selectively controls the switch 304 based on various inputs such as the current, a direction of the current flow, and a temperature of the battery 100. The switch 304, in this instance, may be a current limiting switch.

A power component 302 supplies power for active components of the battery management circuit 110. In the illustrated example, the power component 302 receives power from the cell 108 and supplies suitable power to the active components. In one instance, the power component 302 includes a boost circuit (not shown) to step up the received power. For example, in one embodiment the cell 108 supplies from about 0.5 volts direct current (VDC) to about 1.7 VDC to the power component 302. The boost circuit of the power component 302 boosts the received voltage to produce an output voltage greater than 1.7 VDC, such as about 5 or 9 VDC. In another embodiment, the boost circuit is configured for another operating voltage range.

A current direction sensor 308 senses the direction of the current flowing from the cell 108 through the switch 304 to the load 202, and generates a signal indicative thereof. The signal is provided to the control component 306, which invokes the switch 304 based on the signal. In one instance, when the switch 304 allows current to pass through to the load 202, the signal indicates that the current is flowing in the appropriate direction. In another instance, when current is attempting to flow in the opposite direction, the signal indicates invokes the control component 306 to open the switch. In this instance, current flow through the switch 304 is interrupted or stopped. As such, the switch 304 may behave like an ideal diode in that current is allowed to freely flow in one direction and essentially does not flow in the opposite direction.

A current level sensor 310 senses a level of the current flowing from the cell 108 through the switch 304 to the load 202, and generates a signal indicative thereof. The signal is provided to the control component 306, which invokes the switch 304 based on the signal. In one instance, the signal indicates that the current level is below a preset threshold current level and the switch 304 allows current to pass through to the load 202. In another instance, the signal indicates that the current level is above the preset threshold. In this instance, the signal indicates invokes the control component 306 to open the switch 304, thereby interrupting current flow.

A temperature sensor 312 senses the temperature of the battery 100 and generates a signal indicative thereof. An example of a suitable temperature sensor includes a thermocouple. Alternately temperature sensing can be accomplished onboard a semiconductor or ASIC by means of monitoring temperature sensitive portions of the die circuit itself. The signal is provided to the control component 306, which invokes the switch 304 based on the signal. In one instance, the signal indicates that the temperature is below a preset threshold temperature, which, for example, may indicate that the battery temperature is within operating conditions. In another instance, the signal indicates that the temperature is above the preset threshold. In this instance, the signal invokes the control component 306 to open the switch 304 to interrupt current flow therethrough. The temperature sensor 312 may be configured to continuously, periodically, aperiodically, otherwise sense the temperature.

The battery management circuit 110 may also include a coulomb counter 314 and a state of charge (SOC) determiner 316. The coulomb counter 314 determines a capacity removed during discharge based on the current flow and generates a signal indicative thereof. The SOC determiner 316 generates a signal indicative of the state of charge or the remaining life of the battery 100 based on the signal from the coulomb counter 314. In the illustrated example, the output of the SOC determiner 316 is provided through the cap 106. It is to be appreciated that the signal can be provided with various precision such as in quartiles or coarser or finer resolution. The SOC determiner 316 may also be omitted.

It is to be appreciated that the battery management circuit 110 may also include memory. Various algorithms and/or instructions may be stored in the memory and executed by the control component 306 and/or another processor. In addition, various information such as historical information, information about the manufacturing process, date(s), current direction, current magnitude, temperature, SOC and/or other information can be stored in the memory and retrieved therefrom, for example, through the cap 106 and/or otherwise.

FIGS. 4, 5 and 6 illustrate example switches 304. FIGS. 4 and 5 show examples including two n-type MOSFETS (Metal Oxide Semiconductor Field Effect Transistors), whereas the example of FIG. 6 includes a single n-type MOSFET. P-type MOSFETS may alternatively be used. Common Drain, common Source, and/or Drain-Source connected MOSFETS are contemplated. The MOSFETS are controlled to transition between an active and an inactive state, thereby allowing and interrupting current flow. As described in greater detail below, the MOSFETS have relatively low resistance when active and relatively high resistance when inactive, essentially stopping current flow except for the leakage current of the MOSFETS. The MOSFETS also do not dissipate any significant heat when inactive.

Initially referring to FIG. 4, a common Source configuration is illustrated. In one instance, the two MOSFETS together have a resistance of about 17 mΩ, which is about 50% of the resistance of a PTC device. The leakage current is on the order of about 1 μA (micro-Amphere) to about 350 mA (milli-Amphere). In a forced discharge mode, the two MOSFETS, when off (V_{gate}=0V) have protected that the battery up to about 19 V, with a leakage current less than 1 μA. In reversal mode, the diode was bridged at about 4.5 V.

Turning to FIG. 5, another common Source example is shown. As above, the two MOSFETS have a resistance of about 17 mΩ. With both forced discharge and reversal modes, the two MOSFETS, when off (V_{gate}=0V) have protected that the battery up to about 19 V, with a leakage current of about 1 μA.

In a p-type MOSFET example, the two MOSFETS again have a resistance of about 17 mΩ. With both forced discharge and reversal modes, the two MOSFETS, when off (V_{gate}=0V) has protected that the battery up to about 19 V, with a leakage current of about 1 μA.

It is to be appreciated that the MOSFETS may alternatively be configured in a parallel configuration, reducing their aggregate resistance to about 10 mΩ.

FIG. 6 shows an example of a single MOSFET switch 304. In this example, the MOSFET has a resistance of about 9 mΩ. The leakage current, when the switch is off (V_{gate}=9V), is less than about 1 mA.

Other types of FETS and/or active components are also contemplated.

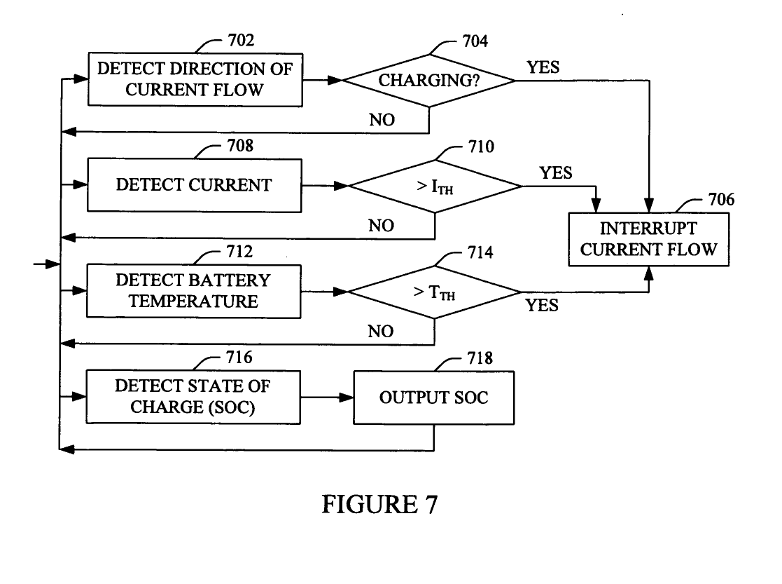

Operation is illustrated in connection with FIG. 7. It is to be appreciated that the order of below acts is not limiting and the acts may be performed in a different order. In addition one or more of the acts may be omitted and/or one or more additional acts may be added.

At 702, the direction of the current flow is sensed. At 704, if the direction of the current indicates a charging state, then current flow is interrupted at 706. Otherwise, current can still flow.

At 708, the current is sensed. At 710, if the current is greater than a temperature threshold, then current flow is interrupted, reduced or pulsed at 706, for example, so that the time average current is less than pre-determined, critical value, thereby allowing the battery to cool down. Otherwise, current can still flow.

At 712, the temperature of the battery is sensed. At 714, if the temperature is greater than a temperature threshold, then current flow is interrupted at 706. Otherwise, current can still flow.

At 716, the state of charge of the battery is determined, and at 718 the state of charge is output through a terminal of the battery. The output voltage of the battery could carry a superimposed information signal on top of the main battery voltage and associated power to the device. This information could be in the form of Pulse Width Modulated (PWM) or Pulse Frequency Modulated (PFM) signal or other binary encoded signal implemented by varying the output voltage of the battery by means of the FETs from some standard level (1.5V) to some other level 1.0V for a period of time such that information about the battery (such as SOC) can be communicated without causing a power interruption on the down stream device. This can be implemented in a variety of ways including but not limited to the use of analog to digital converters or comparators on the down stream device to sense the variations in incoming voltage (the superimposed information).

The application has been described with reference to various embodiments. Modifications and alterations will occur to others upon reading the application. It is intended that the invention be construed as including all such modifications and alterations, including insofar as they come within the scope of the appended claims and the equivalents thereof.

What is claimed is:

1. A non-rechargeable battery, comprising:
a housing with an opening;
a cover that closes the opening in the housing, wherein the housing and the cover define a volumetric region within the battery;
at least one electrochemical cell located in the volumetric region; and
a management component located in the volumetric region, wherein the management component includes programmable electrical circuitry that selectively interrupts electrical current output from the cell out of the battery based on an actively monitored state of the battery.

2. The battery of claim 1, wherein a chemistry of the battery is a Li—FeS₂.

3. The battery of claim 1, wherein the management component is an integrated chip.

4. The battery of claim 1, wherein the management component includes an active electrical component.

5. The battery of claim 1, wherein the management component is located in the cover.

6. The battery of claim 1, wherein the management component is located between the at least one cell and the cover, and the at least one cell is in electrical communication with a terminal of the cover through the management component.

7. The battery of claim 1, wherein the management component is located between the at least one cell and the housing, and the at least one cell is in electrical communication with the housing through the management component.

8. The battery of claim 1, wherein the management component further includes:
a microprocessor that selectively controls electrical current to flow through the battery.

9. The battery of claim 8, wherein the management component further includes:
an electrical current sensor that senses an electrical current of the at least one cell, wherein the microprocessor selectively opens and closes a switch based on the sensed electrical current.

10. The battery of claim 8, wherein the management component further includes:
an electrical current direction sensor that senses a direction of the electrical current in the at least one cell, wherein the microprocessor selectively opens and closes a switch based on the sensed direction of the electrical current.

11. The battery of claim 8, wherein the management component further includes:
a temperature sensor that senses a temperature of the battery, wherein the microprocessor selectively opens and closes a switch based on the sensed temperature.

12. The battery of claim 1, wherein the management component further includes:
a state of charge determiner that determines a state of charge of the at least one cell.

13. The battery of claim 12 wherein the state of charge determiner provides the determined state of charge through a data output terminal of the battery.

14. A method of controlling an electrical current output of a primary battery, comprising:
determining an electrical operating characteristic of the primary battery; and
executing an executable instruction contained within battery that causes interruption of the electrical current output of the primary battery based on the electrical operating characteristic.

15. The method of claim 14, wherein the electrical operating characteristic is a magnitude of the electrical current.

16. The method of claim 14, wherein the electrical operating characteristic is a direction of the electrical current.

17. The method of claim 15, further including:
determining a temperature of the battery; and
interrupting the electrical current output of the battery when the temperature exceeds a configurable temperature threshold.

18. The method of claim 16, further including:
determining a state of charge of the battery; and
outputting the state of charge through a terminal of the battery.

19. The method of claim 16, wherein the battery is a Li—FeS₂ battery.

20. A primary battery, comprising:
an electrochemical cell contained within a housing;
an output terminal formed on or within the housing;
a switch located between the cell and the output terminal, wherein the switch includes an active electrical component that is powered by the cell;
a microprocessor that controls the switch so as to prevent electrical current flow from the cell through the switch and to the output terminal under a preset condition, wherein the microprocessor is also contained within the housing.

21. The primary battery of claim 20, further including an electrical current level sensor that determines a level of the electrical current flow from the cell, and the microprocessor controls the switch so as to prevent electrical current flow through the switch when the level exceeds a preset programmable current level threshold.

22. The primary battery of claim 21, further including an electrical current direction sensor that determines a direction of the electrical current flow of the cell, and the microprocessor controls the switch so as to prevent electrical current flow through the switch when the direction does not satisfy a preset programmable electrical current direction.

23. The primary battery of claim 22, further including a temperature sensor that determines a temperature of the battery, and the microprocessor controls the switch so as to prevent electrical current flow through the switch when the temperature exceeds a preset programmable temperature threshold.

24. The primary battery of claim 23, further including a state of charge determiner that determines a state of charge of the battery, wherein the microprocessor outputs the state of charge through the terminal.

25. The primary battery of claim 24, wherein the switch includes one or more field effect transistors.

26. The primary battery of claim 25, further including a boost circuit that boosts the voltage of the cell to a voltage suitable to power the switch.

27. The primary battery of claim 20, wherein the switch includes at least one field effect transistors.

28. The primary battery of claim 27, wherein there are at least two transistors provided in series.

29. The primary battery of claim 27, further including a boost circuit that boosts the voltage of the cell to a voltage suitable to power the switch.

30. The primary battery of claim 20, wherein there are two switches and wherein each switch is located between the cell and the output terminal.

31. The primary battery of claim 20, further comprising a positive temperature coefficient device located between the cell and the output terminal.

32. The primary battery of claim 20, wherein the cell is a Li—FeS₂ cell.

33. The primary battery of claim 20, wherein the switch and the microprocessor are part of a single application specific integrated circuit.
